(19) United States
(12) Patent Application Publication
(10) Pub. No.: US 2025/0165811 A1
(43) Pub. Date: May 22, 2025

(54) MATURITY STATE-BASED WORKPLACE ACTIVITY ASSIGNMENT USING DIGITAL TWIN-BASED SIMULATION

(71) Applicant: International Business Machines Corporation, Armonk, NY (US)

(72) Inventors: Jennifer M. Hatfield, Portland, OR (US); Jeremy R. Fox, Georgetown, TX (US); Tushar Agrawal, West Fargo, ND (US); Sarbajit K. Rakshit, Kolkata (IN)

(21) Appl. No.: 18/511,659

(22) Filed: Nov. 16, 2023

(51) Int. Cl. G06N 5/022

(52) U.S. Cl. CPC G06N 5/022

(57) ABSTRACT

An approach for assigning an activity to an optimal workplace. A plurality of different maturity levels are measured for each of a plurality of different workplace environments. Each of these maturity levels corresponds to one of a number of critical success factors of the corresponding workplace. In addition, a set of critical success factors and a required maturity necessary for each of the critical success factors in order to perform an activity is determined. Based on the maturity levels of the workplace environments and the critical success factors of the activities, the performance of the activity on each of the plurality of different workplace environments is simulated using a digital twin of each workplace environment. Based on the simulating, an optimal workplace for the activity is determined, and the activity is assigned to the optimal workplace.

The present invention relates to task management. Specifically, the present invention relates to utilizing digital twin-based simulation to assess the suitability of an activity for a particular workplace based on maturity state.

### BACKGROUND

In various working environments, different types of workers are often needed to perform distinct types of activities, with some of the activities being manual, others being automatic, and still others being semi-automatic. Because of this, there is usually no ideal workplace that is optimal for every activity that may need to be performed. Large corporations and other entities often have a large number of activities that have varied natures that need to be performed in order for the entity to accomplish its strategic goals. In order to facilitate this, these entities often have a number of available workplaces, which may be internal and/or external to the entity, that the entity can leverage for performing the activities. Various activities can be assigned to these workplaces, where they can be performed on behalf of the entity.

Maturity models can be one tool used to quantify aspects of a particular workplace and/or to compare a number of different workplaces. A maturity model is a systematic framework that has a number of structured levels pertaining to one or more different aspects that pertain to the reliability and sustainability of the outputs produced by the workplace. Each of these structured levels is usually defined by a set of requirements that need to be met in order to reach it, with each successive level requiring incrementally more stringent requirements to be met in order to reach the level from the preceding structured level. For examine, the maturity model set forth by the International Organization for Standardization (ISO) includes the following structured levels:
0—Incomplete: No process implemented or little/no evidence of any systematic achievement of the process purpose
1—Performed: The process achieves its expected purpose
2—Managed: The process is implemented in a managed way (planned, monitored, and adjusted) with appropriately established, controlled, and maintained work products
3—Established: The process is implemented using a defined (standard) process that is capable of achieving the expected outcomes
4—Predictable: The process operates within defined limits to achieve its expected outcomes
5—Optimized: The process is continuously improved to meet relevant current and projected enterprise goals
   The first two levels are generally related to punctual processes and individual knowledge required to make the process work as expected, while the last three levels require an enterprise view and corporate knowledge to make different processes of different organizational units work together.

As generally understood, in computing systems, a digital twin is a virtual replica of a physical product, process, or system that can help bridge physical and digital worlds. In essence, a digital twin is a computer program that takes real-world data about a physical object or system as inputs and produces as outputs predications or simulations of how that physical object or system will be affected by those inputs. This allows the digital twin to simulate the physical object in real time, in the process offering insights into performance and potential problems.

### SUMMARY

Embodiments of the invention present invention provide an approach for assigning an activity to an optimal workplace. A plurality of different maturity levels are measured for each of a plurality of different workplace environments. Each of these maturity levels corresponds to one of a number of critical success factors of the corresponding workplace. In addition, a set of critical success factors and a required maturity necessary for each of the critical success factors in order to perform an activity is determined. Based on the maturity levels of the workplace environments and the critical success factors of the activities, the performance of the activity on each of the plurality of different workplace environments is simulated using a digital twin of each workplace environment. Based on the simulating, an optimal workplace for the activity is determined, and the activity is assigned to the optimal workplace.

One aspect of the present invention includes a computer-implemented method for assigning an activity to an optimal workplace, comprising the computer-implemented steps of: measuring, for each workplace environment of a plurality of different workplace environments, a plurality of different maturity levels, each maturity level of the plurality of different maturity levels corresponding to a critical success factor from a plurality of different critical success factors of the workplace environment; determining a set of critical success factors and a required maturity necessary for each of the set of critical success factors in order to perform the activity; simulating a performance of the activity on each of the plurality of different workplace environments using a digital twin of each workplace environment based on a respective maturity level of a respective workplace environment and respective critical success factors and the set of critical success factors of the activity; determining the optimal workplace for the activity based on the simulating; and assigning the activity to the optimal workplace.

A second aspect of the present invention provides a system for assigning an activity to an optimal workplace, comprising: a memory medium comprising program instructions; a bus coupled to the memory medium; and a processor, for executing the program instructions, coupled to the memory medium that when executing the program instructions causes the system to: measure, for each workplace environment of a plurality of different workplace environments, a plurality of different maturity levels, each maturity level of the plurality of different maturity levels corresponding to a critical success factor from a plurality of different critical success factors of the workplace environment; determine a set of critical success factors and a required maturity necessary for each of the set of critical success factors in order to perform the activity; simulate a performance of the activity on each of the plurality of different workplace environments using a digital twin of each workplace environment based on a respective maturity level of a respective workplace environment and respective critical success factors and the set of critical success factors of the activity; determine the optimal workplace for the activity based on the simulating; and assign the activity to the optimal workplace.

A third aspect of the present invention provides a computer program product for assigning an activity to an optimal workplace, the computer program product comprising: a computer readable storage device, and program instructions stored on the computer readable storage media, to: measure, for workplace environment each of a plurality of different workplace environments, a plurality of different maturity levels, each maturity level of the plurality of different maturity levels corresponding to a critical success factor from a plurality of a different critical success factors of the workplace environment; determine a set of critical success factors and a required maturity necessary for each of the set of critical success factors in order to perform the activity; simulate a performance of the activity on each of the plurality of different workplace environments using a digital twin of each workplace environment based on a respective maturity level of a respective workplace environment and respective critical success factors and the set of critical success factors of the activity; determine the optimal workplace for the activity based on the simulating; and assign the activity to the optimal workplace.

### BRIEF DESCRIPTION OF THE DRAWINGS

These and other features of this invention will be more readily understood from the following detailed description of the various aspects of the invention taken in conjunction with the accompanying drawings in which:

FIG. 1 shows an architecture in which the invention may be implemented according to an embodiment of the present invention;

FIG. 2 shows a system diagram describing the functionality discussed herein according to an embodiment of the present invention;

FIG. 3 shows an example workplace environment according to an embodiment of the present invention;

FIG. 4 shows a block diagram that illustrates a system according to illustrative embodiments;

FIG. 5 shows a logical flow diagram according to illustrative embodiments;

FIG. 6 depicts a method flow diagram for assigning an activity to an optimal workplace using digital twin-based simulation according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

Illustrative embodiments will now be described more fully herein with reference to the accompanying drawings, in which exemplary embodiments are shown. This disclosure may, however, be embodied in many different forms and should not be construed as limited to the embodiments set forth herein. Rather, these illustrative embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof. Furthermore, the term “developer” refers to any person who writes computer software. The term can refer to a specialist in one area of computer programming or to a generalist who writes code for many kinds of software.

As indicated above, embodiments of the invention present invention provide an approach for assigning an activity to an optimal workplace. A plurality of different maturity levels are measured for each of a plurality of different workplace environments. Each of these maturity levels corresponds to one of a number of critical success factors of the corresponding workplace. In addition, a set of critical success factors and a required maturity necessary for each of the critical success factors in order to perform an activity is determined. Based on the maturity levels of the workplace environments and the critical success factors of the activities, the performance of the activity on each of the plurality of different workplace environments is simulated using a digital twin of each workplace environment. Based on the simulating, an optimal workplace for the activity is determined, and the activity is assigned to the optimal workplace.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

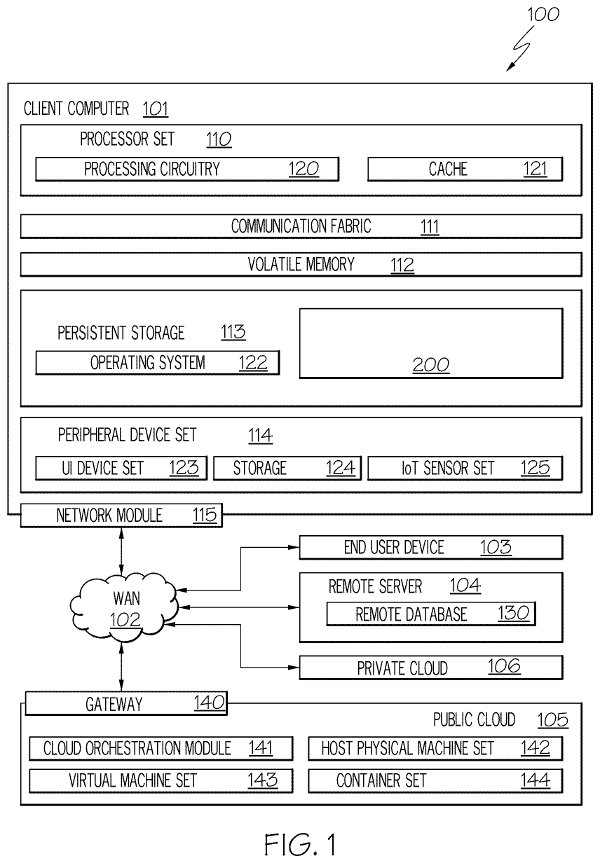

Referring now to FIG. 1, computing environment 100 contains an example of an environment for the execution of at least some of the computer code involved in performing the inventive methods, such as optimal workplace placement engine 200 (hereinafter “system 200”). In addition to system 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and system 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in system 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

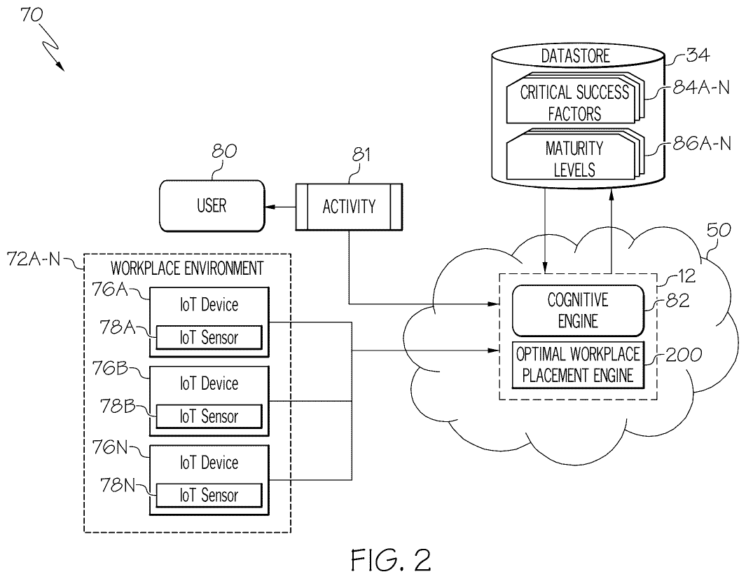

Referring now to FIG. 2, a system diagram describing the functionality discussed herein according to an embodiment of the present invention is shown. It is understood that the teachings recited herein may be practiced within any type of networked computing environment 70 (e.g., a cloud computing environment 50). A stand-alone computer system/server 12 is shown in FIG. 2 for illustrative purposes only. In the event the teachings recited herein are practiced in a networked computing environment, each client need not have an optimal workplace placement engine (hereinafter “system 90”). Rather, all or part of system 90 could be loaded on a server or server-capable device that communicates (e.g., wirelessly) with the clients to provide for assigning an activity to an optimal workplace using digital twin-based simulation.

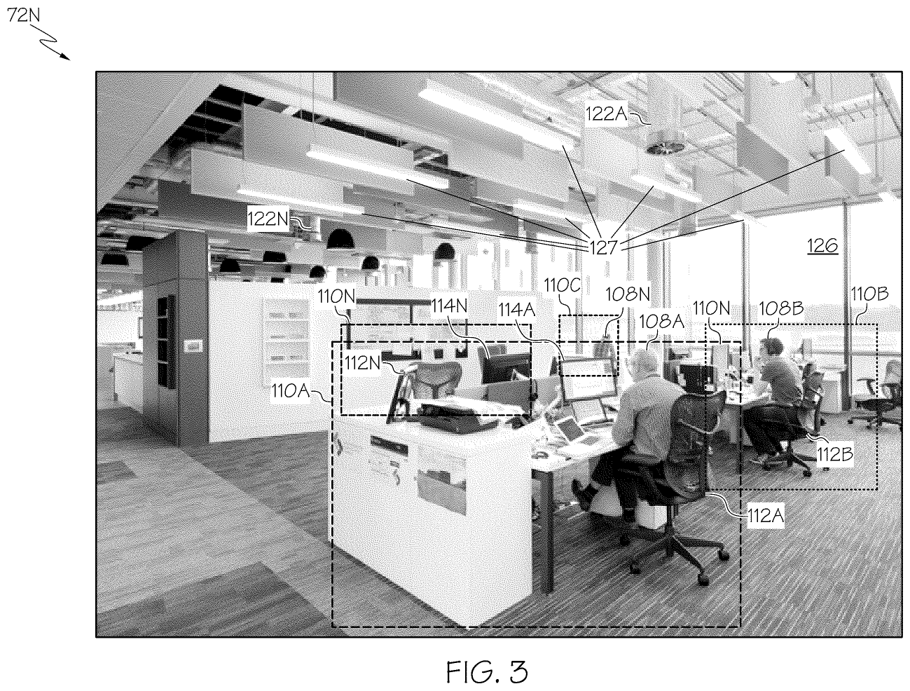

Referring now to FIG. 3, an example workplace environment 72N according to an embodiment of the present invention is shown. In the illustrated example, workplace environment is depicted as an open office environment. However, it should be understood that workplace environment could include any environment in which one or more workers 108A-N (hereinafter generic singular 108N, generic plural 108A-N) perform an activity. To this extent, workplace environment can include a traditional office environment, an open office environment, a production environment, an industrial environment, a workshop environment, a warehouse environment, a construction environment, and/or any other indoor or outdoor environment in which a worker performing a work task may be located.

As illustrated, workplace environment 72N includes a number of individual work areas 110A-N (hereinafter generic singular 110N, generic plural 110A-N), with one or more workers 108A-N being assigned to one or more individual work area 110N. It should be understood that the boundaries of a particular individual work area need not be exclusive of all other individual work areas 110A-N, but, rather, the boundaries of two or more work areas 110A-N may overlap, such that the workers 108A-N assigned to the overlapping work areas 110A-N are required to share all or a portion of their individual work areas 110A-N. Moreover, in a shared space workplace solution, a plurality of different workers 108A-N may be assigned to the same individual work area over different periods of time.

In any case, each individual work area 110N can include one or more internal features. Internal features can be thought of as objects, structures, and/or the like that are located within the individual work area 110N that can impact the work task being performed by worker 108N. As shown, each individual work area 110N has internal features that can include a seating apparatus 112N (hereinafter generic singular 112N, generic plural 112A-N) and a computing device 114N (hereinafter generic singular 114N, generic plural 114A-N), among others.

In addition, workplace environment 72N can contain a number of external features. External features can be thought of as objects, structures, and/or the like that are located outside of the individual work area 110N that can impact the work task being performed by worker 108N. As illustrated, work environment 100 has external features that include a number of temperature regulation sources 122A-N and natural light sources 126 and a number of man-made light sources 127.

The presence or absence of certain internal or external features in a particular workplace environment 72N can impact the ability of the workplace environment 72N to perform particular types of activities and/or activities in general. For example, the number and type of available computing devices 114A-N, servers, the amount and type of lighting, etc., can impact the productivity and safety of workers 108A-N performing one or more types of activities in workplace environment 72N. In another example, the absence of such external features as firewalls, virtual private networks, backup equipment, etc., can impact cyber security and/or ability to recover from disasters while performing one or more type of activities within workplace environment 72N. Moreover, other factors that are not easily observable from internal or external factors can also impact how efficiently and effectively a particular activity can be performed by the workplace environment 72N. For example, certain activities may require workers 108A-N who have particular skills. In addition, the health of machines used by workers 108A-N may have an impact on the ability of workers 108A-N to complete the activity according to specifications and in a timely manner.

The inventors of the invention described herein have discovered a number of deficiencies in the way in which activities are assigned to different workplaces. For example, current solutions for assigning activities to a workplace fail to take into account the maturity level of potential workplaces. Rather, to the extent, if any, that current solutions consider strengths and weaknesses of candidate workplaces, they fail to do so using a widely used structured rubric, much less using maturity models. Still further, current solutions fail to determine the level of maturity required to execute each activity in order to understand the threshold in areas, such as optimal quality, cost parameters, safety, security factors, etc. Moreover, these solutions fail to assign maturity model-based ratings to each critical area of the workplace and to assign the activity to an optimal workplace based on an aligning of required maturity level for the activity and existing maturity level of the workplace for each attribute.

The invention described herein utilizes a digital twin to simulate an activity, which is to be performed, in the environment of each of a number of workplaces to determine an optimal workplace for the activity to be assigned based on the maturity level of the workplace and maturity levels required for effective completion of the activity. A digital twin is a digital replica of a product, process, or service. This living model creates a thread between the physical and digital world. In an embodiment, IoT-connected objects are replicated digitally, enabling simulations, testing, modeling, and monitoring based on data collected by IoT sensors. Like everything in the realm of IoT, data is the primary driver, and most invaluable output, of digital twins. The sharing and analysis of digital twin data can empower a user to make decisions which directly impact her concentration and/or performance.

One advantage of the solution provided by the present invention is that it allows the activities and workplace to be evaluated according to well established and commonly used rating systems. Using the identified maturities required to perform an activity and maturity levels of the workplace relating to each attribute, the digital twin utilized by the current invention can provide the user with a tool that allows the user to evaluate the performance of the activity on each potential workplace in the context of the workplace environment. The digital twin can perform these evaluations in the context of a simulated production environment in which other activities that are currently assigned to each workplace are also virtually performed. The results of these simulations can be used in conjunction with digital twin simulations for other activities, using the activity and workplace-based maturity ratings, to create a distributed workflow in which activity assignment is balanced, with overall optimization of activity assignment to optimal workplaces. The resulting optimization of workplace activity assignment creates an environment in which the activities are performed in a more effective manner and workplaces are more productive, saving time and resources.

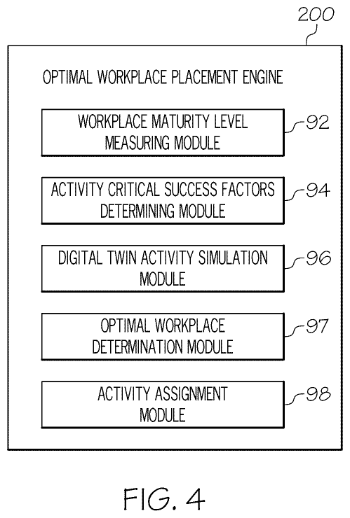

Referring now to FIG. 4, a block diagram that illustrates system 90 is depicted according to illustrative embodiments. It should be understood that system 90 can be implemented as program/utility 40 on stand-alone computer system/server 12 of FIG. 1 and can enable the functions recited herein. Along these lines, system 90 may perform multiple functions. Specifically, among other functions, system 90 can assign an activity to an optimal workplace using digital twin-based simulation in a networked computing environment. To accomplish this, system 90 can include a set of components (e.g., program modules 42 of FIG. 1) for carrying out embodiments of the present invention. These components can include, but are not limited to, workplace maturity level measuring module 92, activity critical success factors determining module 94, digital twin activity simulation module 96, optimal workplace determination module 96, and activity assignment module 98.

Referring now to FIG. 2 in conjunction with FIGS. 3 and 4, workplace maturity measuring module 92, as executed by computer system/server 12, is configured to measure a plurality of different maturity levels 86A-N (hereafter generic singular 86N and plural 86A-N) for each of a plurality of different workplace environments 72A-N (hereafter generic singular 72N and plural 72A-N). Each of the maturity levels 86A-N measured by workplace maturity measuring module 92 corresponds to one of a plurality of critical success factors 84A-N (hereafter generic singular 84N and plural 84A-N of the workplace environment 72N. Critical success factors 84A-N for which maturity levels 86A-N are measure can include, but are not limited to, cyber security, safety, recovery speed, skills, health of machines, and/or the like.

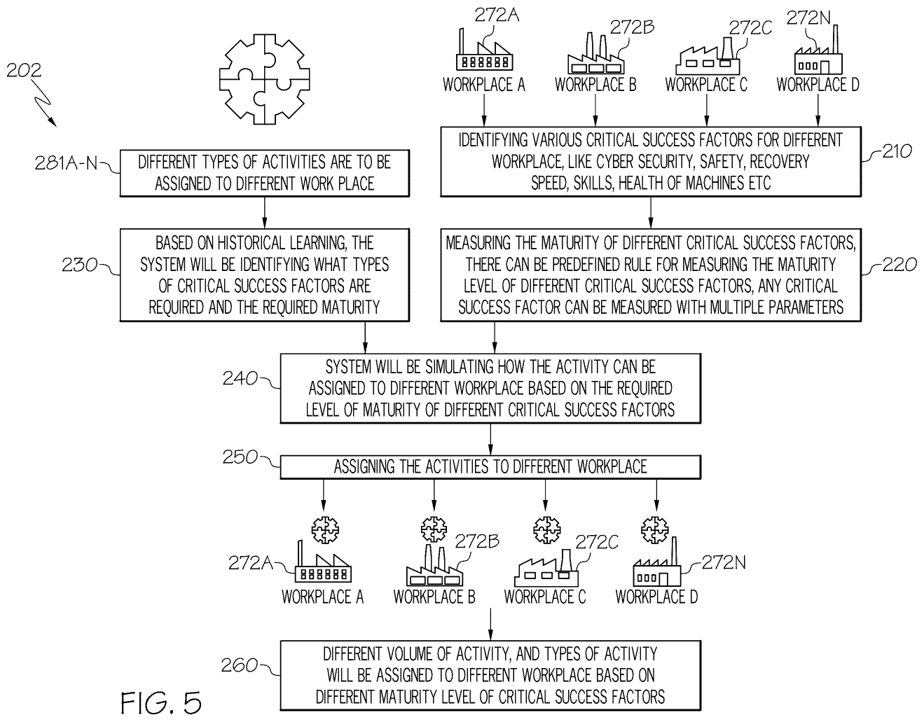

Referring now additionally to FIG. 5, a logical flow diagram is shown according to embodiments. As shown, logic flow starts with a plurality of workplaces 272A-N (hereafter generic singular 272N and plural 272A-N). In preparing to assign any activity 281A-N (hereafter generic singular 281N and plural 281A-N) to any workplace, specific information is analyzed to identify what types of critical success factors 84A-N (e.g., Safety, Security, health of machine, turnaround time, etc.) are to be considered for the workplace and what should be the minimum level of maturity of those critical success factors. Accordingly, at 210, critical success factors 84A-N are identified by measuring each workplace 272A-N with different types of critical success factors 84A-N, which include the parameters which can contribute to the successful completion of the activity 81.

In an embodiment, workplace information relating to critical success factors 84A-N can be measured within workplace environment 72N using a set of IoT sensors 78A-N (hereafter generic singular 78N and plural 78A-N). Each IoT sensor 78A-N measures one or more physical quantity within workplace environment 72N and converts it into a signal. IoT sensors 78A-N translate measurements from the real world into data for the digital domain. Parameters that can be measured can include, but are not limited to, location, displacement, movement, sound frequency, temperature, pressure, humidity, electrical voltage level, camera images, color, chemical composition, number of workers, movement of workers, accidents, equipment numbers, equipment types, equipment locations, equipment operating parameters, and/or the like.

Though this disclosure pertains to the collection of personal data (e.g., workplace data), it is noted that in embodiments, users 80 opt-in to the system (e.g., optimal workplace placement engine 200). In doing so, they are informed of what data is collected and how it will be used, that any collected personal data may be encrypted while being used, that users can opt-out at any time, and that if they opt-out, any personal data of the user is deleted.

In order to enable sensors for obtaining the environmental information, once a user 80, who wants to utilize the functionality described herein has opted in, workplace maturity measuring module 92 can enroll any number of IoT devices 76A-N within workplace environment 72. This enrolling can allow for automated discovery and identification of each IoT device 76A-N, rather than requiring manual input of device identifiers. The process may be similar to Bluetooth or network discovery tools on computers and mobile devices, or the like. Once the available devices within workplace environment 72 are identified, user 80 can choose to add the devices into a central registry. This updated list of devices reflects the enrolled set of devices that can be used for digital-twin simulation. Alternatively, or in addition, manual input of IoT device identifiers can be used.

IoT devices 76A-N within workplace environment 72 can by classified into a number of different types. Consumer-related IoT devices can include smart TVs, smart speakers, toys, wearables, and smart appliances. Smart meters, commercial security systems and smart city technologies, such as those used to monitor traffic and weather conditions, are examples of industrial and enterprise IoT devices. Other technologies, including smart air conditioning, smart thermostats, smart lighting, and smart security, can span home, enterprise, and industrial uses. As discussed, IoT devices are nonstandard computing devices that connect wirelessly to a network and have the ability to transmit data. IoT typically involves extending Internet connectivity beyond standard devices, such as desktops, laptops, smartphones, and tablets, to any range of traditionally non-Internet-enabled physical devices and everyday objects. Embedded with technology, these devices can communicate and interact over the Internet. Connected devices are part of an ecosystem in which every device can talk to other related devices in an environment to automate home or industry tasks. They can communicate usable sensor data to users, businesses, and other intended parties.

In any case, workplace maturity measuring module 92 can capture device data from each enrolled IoT device 76A-N. Device data can include, but is not limited to, device type, functionalities and capabilities of each device, any workflows among the devices, location and/or mobility of each device, usage behavior of each device, and/or the like. While some IoT devices, such as a thermostat or cleaning robot, can impact any person within a smart environment, mobile IoT devices (e.g., smart watch, belt, or phone) are typically associated with the person carrying the device. Therefore, for any mobile devices enrolled in the system, device enrolling module 52 can also capture an identity of the opted-in person (e.g., person's name, unique identifier, etc.) using the device which can prove useful when analyzing data collected by the device. The association process can be lightweight and as simple as selecting the person's devices from a list of recognized devices having been previously enrolled. Other devices, particularly non-mobile devices such as a cleaning robot, can be associated with all persons within the smart workplace environment 72.

In any event, each of IoT devices 76A-N that have been deployed in workplace environment 72 has at least one communications component controlled by the processor of the IoT device 76A-N.

Communications component includes a hardware communicator and a software agent that includes standard protocols used in the IoT environment. To this extent, communications component is designed to be able to process communications from IoT devices 76A-N, determine the protocols of the processed communications, and interpret the communications in order to facilitate interoperability among IoT devices 76A-N. In order to accomplish this, a single communications component can be designed to process a single type of communication, multiple types of communications, or all types of communications technologies. Communications components in multiple IoT devices 76A-N can collaborate to determine the type of communication used to share the collected environmental information.

Additionally, or in the alternative, critical success factors 84A-N can be monitored by accessing previously recorded data (e.g., in a datastore 34. In addition to saved data from IoT sensors 78A-N, the data in datastore can include information regarding workplace certifications, on-time statistics, machine downtime, employee certifications, employee skills, employee injuries, data breaches, customer satisfaction, social media data related to the workplace 272N, and/or the like.

In any case, once critical success factors 84A-N have been identified and measured for workplaces 272A-N, a maturity level 86N for each critical success factor 84N can be assigned to each workplace 272N. A single critical success factor 84N can have different levels of maturities, and each different level of maturity can result in a different outcome for performance of any activity 81. To this extent, at 220, a pre-defined rule is used by workplace maturity level measuring module 92 to measure the maturity level 86N associated with each critical success factor 84N. Moreover, in instances in which a single pre-defined rule is not sufficient for the specific critical success factor 84N, the critical success factor 84N can be measured with multiple parameters. In an embodiment, the pre-defined rule can be one of a structured set of rules that makes up a maturity model. In an embodiment, the maturity model can be the ISO maturity model. In such a case, each of the critical success factors 84A-N for a particular workplace 272N can be assigned a level within the range 0-5 that is appropriate to maturity levels 86A-N of the workplace 272N. In any case, the measuring of the maturity levels 86A-N can apply rules in the maturity model to measurable attributes corresponding to each critical success factor 84N of the plurality of critical success factors 84A-N of the workplace to determine the maturity level 86N.

Activity critical success factors determining module 94, as executed by computer system/server 12, is configured to determine a set of critical success factors 84A-N and a required maturity necessary for each of the set of critical success factors 84A-N in order to perform an activity 81. Activity 81 can include physical activities with machines, computing activities or combination of both types of activities. To this extent, the successful completion of each of the activities 281A-N may depend on different critical success factors 84A-N at the workplace 272N. To accommodate this, activity critical success factors determining module 94 identifies each activity 281N uniquely along with its unique characteristics. In order to accomplish this, at 230, activity critical success factors determining module 94 uses historical learning to identify what types of critical success factors 84A-N are required and the required maturity.

In an embodiment, a cognitive engine 82 is trained to identify critical success factors of activities in a workplace environment 72N. This can be done by utilizing continuous learning in which a model is trained using data obtained from performing the activity 281N in different workplaces 272A-N for which maturity levels 86A-N have already been determined. Cognitive engine 82 can analyze activities performed on the plurality of workplaces 272A-N using historical learning over time. The success or failure of the performance of the activity 281N can be fed back into the model to continuously update the model, enabling cognitive engine 82 to identify what types of critical success factors 84A-N are required for the activity 281N and the required maturity of each critical success factor 84N that is required for the activity 281N. In an embodiment, the required maturity for one or more of critical success factors 84A-N associated with an activity 281N can include an optimum maturity and a minimal required maturity.

Digital twin activity simulating module 96, as executed by computer system/server 12, is configured to simulate the performance of activity 281N on each of the plurality of different workplace environments 272A-N using a digital twin of each workplace environment. This simulation is performed by the digital twin based on the maturity levels 86A-N of each workplace and the critical success factors 84A-N of the activity 281. As stated, in its basic form, a digital twin is the digital representation of physical or non-physical processes, systems, or objects. The real-time digital representation a digital twin provides serves as a world of its own. Within this digital world, many types of simulation can be run. Simulations can help a user understand what may happen in the real world by enabling accurate prediction and what-if analysis. Digital twin simulations can be often viewed using a display (e.g., mobile device or computer screen, etc.), virtual reality headset, or the like. Alternatively, the digital twin simulation can run to a specified point, at which a set of outputs (e.g., a determination of whether and/or statistics indicating how well activity 281N was performed by each workplace 272N) can be returned to user 80. By understanding real world device behavior using simulations, the user can then use the digital twin, instead of an actual physical device, to make adjustments and visualize any changes in the digital twin in response to the adjustments.

As shown in FIG. 5, at 250, the digital twin simulates how activity 281N can be assigned to different workplace environments 240 based on the required level of maturity of different critical success factors 84A-N that are specific to the activity 281N. To accomplish this, digital twin activity simulating module 96 can identify from the maturity levels 86A-N, which have been measured for each workplace 272N, information specific to the performance of specific activities 281A-N in various workplace environments 272A-N. Digital twin activity simulating module 96 can utilize this activity-specific information to determine whether the workplace 272N can provide required critical success factors 84A-N that have been identified as being important for the activity 281N. This simulation of activity 281N performance can be performed by the digital twin while simulating other activities 281A-N that are currently being performed by a particular workplace 272N to determine whether the activity 281N can be performed effectively in the normal operation of the workplace 272N.

In addition, digital twin activity simulating module 96 can create other digital twins that are specific to other workplaces 272A-N. To this extent, a separate digital twin that is specifically focused on each particular workplace 272N can be generated for every activity 281N to be assigned. These individual workplace-specific digital twins can be combined to form an enterprise-wide digital twin that combines the perspectives and focus points of the individual digital twins and that can be used to simulate distribution of a plurality of activities 281A-N among the workplaces 272A-N.

Optimal workplace determination module 97, as executed by computer system/server 12, is configured to determine an optimal workplace for the activity 81 based on the simulating. Optimal workplace determination module 97 takes the results from the digit twin and, at 250, assigns activities 281A-N to different workplaces 272A-N. In making these determinations, optimal workplace determination module 97 can evaluate each workplace 272N that has been identified as meeting critical success factors for the activity 281N. Based on this evaluation, a threshold and scoring system can be activated and tested to measure what is considered the optimum and what is minimally passing maturity level. This scoring system can continually measure the state of the overall workplace. Based on the level of maturity of different critical success factors 84A-N of the activities 281A-N, optimal workplace determination module 97 can recommend an optimal volume of activities 281A-N to be assigned to each workplace 272A-N. Moreover, if multiple activities 281A-N are to be assigned to multiple workplaces 272A-N, optimal workplace determination module 97 can identify how best the activities can be assigned to different workplaces 272A-N so that aggregated effectiveness is maximized.

Activity assignment module 98, as executed by computer system/server 12, is configured to assign the activity 281N to the optimal workplace determined by optimal workplace determination module 97. To accomplish this, activity assignment module 98 can utilize an optimal volume of activities 281A-N to be processed by the optimal workplace that has been determined by optimal workplace determination module 97. Based on this, activity assignment module 98 can schedule the activity 281N together with a plurality of other activities 281A-N at the optimal workplace over time based on the optimal volume of activities. In addition, optimal workplaces 272A-N can be determined for any number of activities 281A-N and these activities 281A-N can be assigned, each to its optimal workplace 272N. Based on the simulating by the digital twin, optimal volume of activities 281A-N to be processed can be determined for each of these workplaces 272A-N. This allows a large number of activities 281A-N to be scheduled on available workplaces 272A-N together with other activities in the workplaces 272A-N in such a way that aggregated effectiveness the workplaces in achieving the critical success factors associated is maximized over all scheduled activities.

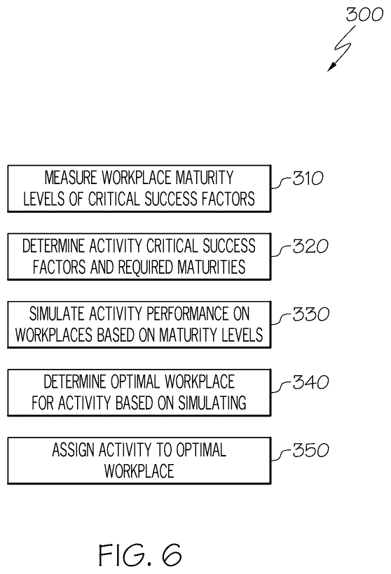

FIG. 6 depicts a method flow diagram 300 for assigning an activity to an optimal workplace using digital twin-based simulation according to an embodiment of the present invention. Referring additionally to FIGS. 2 and 4, at 310, a plurality of different maturity levels 86A-N are measured for each of a plurality of different workplace environments 272A-N. Each maturity level corresponds to a critical success factor 84A-N of the workplace 272N. At 320, a set of critical success factors and a required maturity necessary for each is determined in order to perform an activity 281N. At 330, the performance of the activity 281N is simulated on each of the different workplace environments 272A-N using a digital twin of each workplace environment 281N. This simulation is performed based on the maturity levels of the workplace environments 281A-N and the critical success factors 84A-N of the activity. At 440, an optimal workplace for the activity 281N is determined based on the simulating. At 450, the activity is assigned to the optimal workplace.

As can now be appreciated, disclosed embodiments provide adaptive algorithms for evaluation and prediction of optimal extractors of KVPs for document sets and facilitates the development of an optimized model based on the selected ranking algorithm for field-level extraction. Thus, disclosed embodiments serve to enable improvements in KVP field extraction from documents, as well as improving the efficacy of automated document processing.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for assigning an activity to an optimal workplace, comprising the computer-implemented steps of:
measuring, for each workplace environment of a plurality of different workplace environments, a plurality of different maturity levels, each maturity level of the plurality of different maturity levels corresponding to a critical success factor from a plurality of different critical success factors of the workplace environment;
determining a set of critical success factors and a required maturity necessary for each of the set of critical success factors in order to perform the activity;
simulating a performance of the activity on each of the plurality of different workplace environments using a digital twin of each workplace environment based on a respective maturity level of a respective workplace environment and respective critical success factors and the set of critical success factors of the activity;
determining the optimal workplace for the activity based on the simulating; and
assigning the activity to the optimal workplace.

2. The computer-implemented method of claim 1, wherein the set of critical success factors include cyber security, safety, recovery speed, skills, and health of machines.

3. The computer-implemented method of claim 1, further comprising:
training a cognitive engine to identity critical success factors of activities in a workplace environment;
analyzing, using the cognitive engine, activities performed on the plurality of different workplace environments using historical learning over time; and
identifying, using the cognitive engine, what critical success factors are required for the activity and the required maturity for each of the critical success factors that is required for the activity.

4. The computer-implemented method of claim 1, wherein the measuring of the plurality of different maturity levels comprises applying, for each of the plurality of different critical success factors, a set of rules in a maturity model to measurable attributes corresponding to the critical success factor of the workplace environment to determine the respective maturity level.

5. The computer-implemented method of claim 1, wherein the required maturity for each critical success factor of the set of critical success factors includes an optimum maturity and a minimal required maturity.

6. The computer-implemented method of claim 1, the determining of the optimal workplace for the activity further comprising:
determining an optimal volume of activities to be processed by the optimal workplace based on the simulating; and
scheduling the activity together with a plurality of other activities at the optimal workplace over time based on the optimal volume of activities.

7. The computer-implemented method of claim 6, the determining of the optimal workplace for the activity further comprising:
determining a second optimal workplace for a second activity based on the simulating;
assigning the second activity to the second optimal workplace;
determining a second optimal volume of activities to be processed by the second optimal workplace based on the simulating; and
scheduling the second activity together with a second plurality of other activities at the second optimal workplace over time based on the second optimal volume of activities,
wherein the assigning of the activity and the second activity maximizes an aggregated effectiveness of the plurality of workplaces achieving the critical success factors associated over all scheduled activities.

8. A system for assigning an activity to an optimal workplace, comprising:
a memory medium comprising program instructions;
a bus coupled to the memory medium; and
a processor, for executing the program instructions, coupled to the memory medium that when executing the program instructions causes the system to:
measure, for each workplace environment of a plurality of different workplace environments, a plurality of different maturity levels, each maturity level of the plurality of different maturity levels corresponding to a critical success factor from a plurality of different critical success factors of the workplace environment;
determine a set of critical success factors and a required maturity necessary for each of the set of critical success factors in order to perform the activity;
simulate a performance of the activity on each of the plurality of different workplace environments using a digital twin of each workplace environment based on a respective maturity level of a respective workplace environment and respective critical success factors and the set of critical success factors of the activity;
determine the optimal workplace for the activity based on the simulating; and
assign the activity to the optimal workplace.

9. The system of claim 8, wherein the set of critical success factors include cyber security, safety, recovery speed, skills, and health of machines.

10. The system of claim 8, the program instructions further causing the system to:
train a cognitive engine to identity critical success factors of activities in a workplace environment;
analyze, using the cognitive engine, activities performed on the plurality of different workplace environments using historical learning over time; and
identify, using the cognitive engine, what critical success factors are required for the activity and the required maturity for each of the critical success factors that is required for the activity.

11. The system of claim 10, the program instructions that measure the plurality of different maturity levels comprising applying, for each of the plurality of a different critical success factors, a set of rules in a maturity model to measurable attributes corresponding to the critical success factor of the workplace environment to determine the respective maturity level.

12. The system of claim 9, wherein the required maturity for each of the critical success factors includes an optimum maturity and a minimal required maturity.

13. The system of claim 12, the program instructions that determine the optimal workplace for the activity further causing the system to:
determine an optimal volume of activities to be processed by the optimal workplace based on the simulating; and
schedule the activity together with a plurality of other activities at the optimal workplace over time based on the optimal volume of activities.

14. The system of claim 8, the program instructions that determine the optimal workplace for the activity further causing the system to:
determine a second optimal workplace for a second activity based on the simulating;
assign the second activity to the second optimal workplace;
determine a second optimal volume of activities to be processed by the second optimal workplace based on the simulating; and
schedule the second activity together with a second plurality of other activities at the second optimal workplace over time based on the second optimal volume of activities,
wherein the assigning of the activity and the second activity maximizes an aggregated effectiveness of the plurality of workplaces achieving the critical success factors associated over all scheduled activities.

15. A computer program product for assigning an activity to an optimal workplace, the computer program product comprising a computer readable storage device, and program instructions stored on the computer readable storage device, to:
measure, for workplace environment each of a plurality of different workplace environments, a plurality of different maturity levels, each maturity level of the plurality of different maturity levels corresponding to a critical success factor from a plurality of a different critical success factors of the workplace environment;
determine a set of critical success factors and a required maturity necessary for each of the set of critical success factors in order to perform the activity;
simulate a performance of the activity on each of the plurality of different workplace environments using a digital twin of each workplace environment based on a respective maturity level of a respective workplace environment and respective critical success factors and the set of critical success factors of the activity;
determine the optimal workplace for the activity based on the simulating; and
assign the activity to the optimal workplace.

16. The computer program product of claim 15, the program instructions stored on the computer readable storage device further to:
train a cognitive engine to identity critical success factors of activities in a workplace environment;
analyze, using the cognitive engine, activities performed on the plurality of different workplace environments using historical learning over time; and
identify, using the cognitive engine, what critical success factors are required for the activity and the required maturity for each of the critical success factors that is required for the activity;
wherein the set of critical success factors include cyber security, safety, recovery speed, skills, and health of machines.

17. The computer program product of claim 16, wherein the program instructions that measure the plurality of different maturity levels comprising applying, for each of the plurality of a different critical success factors, a set of rules in a maturity model to measurable attributes corresponding to the critical success factor of the workplace environment to determine the respective maturity level.

18. The computer program product of claim 17, wherein the required maturity for each of the critical success factors includes an optimum maturity and a minimal required maturity.

19. The computer program product of claim 16, the program instructions that determine the optimal workplace for the activity further operating to:
determine an optimal volume of activities to be processed by the optimal workplace based on the simulating; and
schedule the activity together with a plurality of other activities at the optimal workplace over time based on the optimal volume of activities.

20. The computer program product of claim 19, the program instructions that determine the optimal workplace for the activity further operating to:
determine a second optimal workplace for a second activity based on the simulating;
assign the second activity to the second optimal workplace;
determine a second optimal volume of activities to be processed by the second optimal workplace based on the simulating; and
schedule the second activity together with a second plurality of other activities at the second optimal workplace over time based on the second optimal volume of activities,
wherein the assigning of the activity and the second activity maximizes an aggregated effectiveness of the plurality of workplaces achieving the critical success factors associated over all scheduled activities.
